(19) United States
(12) Patent Application Publication
(10) Pub. No.: US 2013/0233268 A1
(43) Pub. Date: Sep. 12, 2013

(54) ENGINE STARTING APPARATUS

(71) Applicants: Takuya Yamaguchi, Susono-shi (JP); Takashi Kawai, Gotemba-shi (JP)

(72) Inventors: Takuya Yamaguchi, Susono-shi (JP); Takashi Kawai, Gotemba-shi (JP)

(73) Assignee: TOYOTA JIDOSHA KABUSHIKI KAISHA, TOYOTA-SHI, AICHI (JP)

(21) Appl. No.: 13/377,985

(22) PCT Filed: Nov. 8, 2010
(86) PCT No.: PCT/JP10/69853

§ 371 Date: Dec. 13, 2011

(51) Int. Cl. F02N 11/08

(52) U.S. Cl. CPC F02N 11/08
USPC 123/179.3

(57) ABSTRACT

An engine starting apparatus is provided with: a target torque setting device for setting a sum of a cranking base torque for cranking an engine and a vibration controlling torque for suppressing vibration of a power transmission system due to resonance of a damper, as a target torque to be outputted by a motor in cranking the engine; and a motor controlling device for controlling the motor to output the set target torque. The target torque setting device has a base torque controlling device for setting the cranking base torque to a first torque value if the number of revolutions of the engine is less than or equal to predetermined number of revolutions of the engine and for controlling the cranking base torque.

### TECHNICAL FIELD

The present invention relates to an engine starting apparatus for staring an engine in a vehicle such as, for example, a hybrid vehicle, which is provided with the engine and a motor.

### BACKGROUND ART

As this type of apparatus, an apparatus for motoring or cranking an engine with a motor generator connected to a crankshaft of the engine (internal combustion engine) through a damper is known (e.g. refer to patent documents 1 and 2).

For example, the patent document 1 discloses a technology for increasing the number of times to motor and start the engine in the condition that there is little fuel left to be supplied to the engine. For example, the patent document 2 discloses a technology for starting fuel injection to the engine and ignition on the basis of a torsion angle of the damper at the start of the engine.

On the other hand, if the damper is included in a power transmission system (power train) for transmitting the power of the engine, torque variation at the start of the engine likely causes the resonance of the damper, thereby worsening the vibration of the power transmission system. In order to suppress the worse vibration of the power transmission system due to the resonance of the damper, what is known is a technology for applying, from the motor to the engine, a vibration controlling torque for suppressing the resonance of the damper in addition to a torque for cranking, in other words, a torque for increasing the number of revolutions of the engine (hereinafter referred to as a “cranking base torque” as occasion demands) in cranking the engine. The vibration controlling torque is controlled to vary depending on, for example, the position of a piston of the engine.

### PRIOR ART DOCUMENT

### Patent Document

Patent document 1: Japanese Patent Application Laid Open No. 2008-285085
Patent document 2: Japanese Patent Application Laid Open No. 2010-96096

### DISCLOSURE OF INVENTION

### Subject to be Solved by the Invention

However, if a torque obtained by applying the vibration controlling torque to the cranking base torque is outputted from the motor, depending on a time-dependent change in the cranking base torque and the vibration controlling torque, the maximum value of the torque to be outputted from the motor likely becomes greater than that in a case where only the cranking base torque is outputted from the motor and the power consumption of the motor likely increases. Thus, the rated output of a battery for supplying electric power to the motor (i.e. the maximum value of the electric power that the battery can output) needs to be increased, and it is hard to miniaturize the battery, which is technically problematic.

In view of the aforementioned conventional problem, it is therefore an object of the present invention to provide an engine starting apparatus capable of suppressing the vibration of the power transmission system due to the resonance of the damper at the start of the engine and suppressing the power consumption of the motor.

### Means for Solving the Subject

The above object of the present invention can be achieved by an engine starting apparatus installed in a vehicle provided with: an engine; a motor capable of cranking the engine; a power transmission system, including a damper, for transmitting power of the engine to drive wheels; and a battery capable of supplying electric power to the motor, the engine starting apparatus provided with: a target torque setting device for setting a sum of a cranking base torque for cranking the engine and a vibration controlling torque for suppressing vibration of the power transmission system due to resonance of the damper, as a target torque to be outputted by the motor in cranking the engine; and a motor controlling device for controlling the motor to output the set target torque, the target torque setting device having a base torque controlling device for setting the cranking base torque to a first torque value if the number of revolutions of the engine is less than or equal to predetermined number of revolutions of the engine and for controlling the cranking base torque such that the cranking base torque starts to be reduced at a time point at which a piston of the engine is at a top dead center or in a compression stroke and such that the cranking base torque is a second torque value which is less than the first torque value at a time point at which the piton is in an expansion stroke if the number of revolutions of the engine is greater than the predetermined number of revolutions of the engine.

According to the engine starting apparatus of the present invention, when the engine is started, the motor is controlled by the motor controlling device to output the target torque to the engine from the motor and the engine is cranked.

The target torque is set by the target torque setting device. The target torque setting device sets the sum of the cranking base torque and the vibration controlling torque as the target torque. The cranking base torque is a torque to be outputted by the motor in order to crank the engine, in other words, in order to increase the number of revolutions of the engine. The cranking base torque is controlled by the base torque controlling device. Here, the “number of revolutions of the engine” of the present invention means the number of revolutions per unit time of the crankshaft of the engine, and it corresponds to a rotational speed of the crankshaft, or a moving speed of the piston of the engine. The vibration controlling torque is a torque to be outputted by the motor in order to suppress the vibration of the power transmission system due to the resonance of the damper. Typically, the vibration controlling torque is controlled to vary depending on the position of the piston of the engine. The vibration controlling torque is controlled such that the direction of the torque varies between a case where the piston of the engine is in the compression stroke (in other words, in a period in which the piston transfers from a bottom dead point to a top dead point) and a case where the piston of the engine is in the expansion stroke. More specifically, the vibration controlling torque is controlled to reduce a torque outputted by the motor if the piston is in the compression stroke, and the vibration controlling torque is controlled to increase the torque outputted by the motor if the piston is in the expansion stroke. By applying the vibration controlling torque as described above to the engine, it is possible to suppress the vibration of the power transmission system due to the resonance of the damper.

In the present invention, in particular, the base torque controlling device (i) sets the cranking base torque to the first torque value if the number of revolutions of the engine is less than or equal to the predetermined number of revolutions of the engine and (ii) controls the cranking base torque such that the cranking base torque starts to be reduced at the time point at which the piston of the engine is at the top dead center or in the compression stroke and such that the cranking base torque is the second torque value which is less than the first torque value at the time point at which the piton is in the expansion stroke if the number of revolutions of the engine is greater than the predetermined number of revolutions of the engine. In other words, the cranking base torque is set to the first torque until the number of revolutions of the engine increases the predetermined number of revolutions of the engine, and the cranking base torque is controlled to start to be reduced at the time point at which the piston is at the top dead center or in the compression stroke after the number of revolutions of the engine reaches the predetermined number of revolutions of the engine (typically, at a time point at which the piston is at the top dead point or in the compression stroke for the first time after the number of revolutions of the engine reaches the predetermined number of revolutions) and to be the second torque value which is less than the first torque value at the time point at which the piton is in the expansion stroke following the compression stroke.

Thus, for example, it is possible to reduce the power consumption of the motor in the expansion stroke after the number of revolutions of the engine reaches the predetermined number of revolutions of the engine, in comparison with a case where the cranking base torque is set to the first torque value even in the expansion stroke after the number of revolutions of the engine reaches the predetermined number of revolutions of the engine. Therefore, it is possible to reduce the rated output of the battery (the maximum value of the electric power that the battery can output) for supplying the electric power to the motor, thereby miniaturizing the battery. Incidentally, as described above, the vibration controlling torque is typically controlled to reduce the torque outputted by the motor if the piston is in the compression stroke and to increase the torque outputted by the motor if the piston is in the expansion stroke. Thus, if the cranking base torque is set to the same torque value between the compression stroke and the expansion stroke, the target torque is maximal in the expansion stroke.

Here, in the expansion stroke, the rotation of the crankshaft is accelerated by the expansion of the air compressed in a cylinder in the compression stroke. Thus, in the expansion stroke, the number of revolutions of the engine tends to easily increase than in the compression stroke. Thus, in the present invention, the cranking base torque in the expansion stroke is reduced less than the cranking base torque in the compression stroke by the rotation of the crankshaft being accelerated by the expansion of the air compressed in the cylinder in the compression stroke,. This makes it possible to avoid a wasteful increase in the power consumption of the motor in the expansion stroke while increasing the number of revolutions of the engine.

As explained above, according to the engine starting apparatus of the present invention, it is possible to suppress the vibration of the power transmission system due to the resonance of the damper at the start of the engine and to suppress the power consumption of the motor.

In one aspect of the engine starting apparatus of the present invention, the base torque controlling device controls the cranking base torque such that the cranking base torque is greater than the first torque value in at least one portion of a period in which the piston in the compression stroke.

According to this aspect, it is possible to reduce or prevent that an increase in the number of revolutions of the engine is suppressed by the compressed air in the cylinder of the engine, in the period in which the piston is in the compression stroke. This makes it possible to suppress an increased difference in the rate of increase in the number of revolutions of the engine between the period in which the piston is in the compression stroke and a period in which the piston is in the subsequent expansion stroke. Thus, the vibration of the power transmission system can be also suppressed.

The operation and other advantages of the present invention will become more apparent from embodiments explained below.

### BRIEF DESCRIPTION OF DRAWINGS

FIG. 1 is a schematic configuration diagram conceptually showing the configuration of a hybrid vehicle in a first embodiment.

FIG. 2 is a conceptual view for explaining an outline of a method of setting a MG1 command torque in the first embodiment.

FIG. 3 is a flowchart showing a flow of controlling a cranking base torque in the first embodiment.

FIG. 4 is a graph showing one example of a time-dependent change in the cranking base torque and the number of revolutions of an engine in the first embodiment.

FIG. 5 is a conceptual view for explaining an outline of a method of setting a MG1 command torque in a comparative example.

FIG. 6 is a flowchart showing a flow of controlling a cranking base torque in a second embodiment.

FIG. 7 is a graph showing one example of a time-dependent change in the cranking base torque and the number of revolutions of the engine in the second embodiment.

FIG. 8 is a flowchart showing a flow of controlling a cranking base torque in a third embodiment.

FIG. 9 is a graph showing one example of a time-dependent change in the cranking base torque and the number of revolutions of the engine in the third embodiment.

FIG. 10 is a graph showing one example of a time-dependent change in the cranking base torque and the number of revolutions of the engine in the comparative example.

### MODE FOR CARRYING OUT THE INVENTION

Hereinafter, embodiments of the present invention will be explained with reference to the drawings.

### First Embodiment

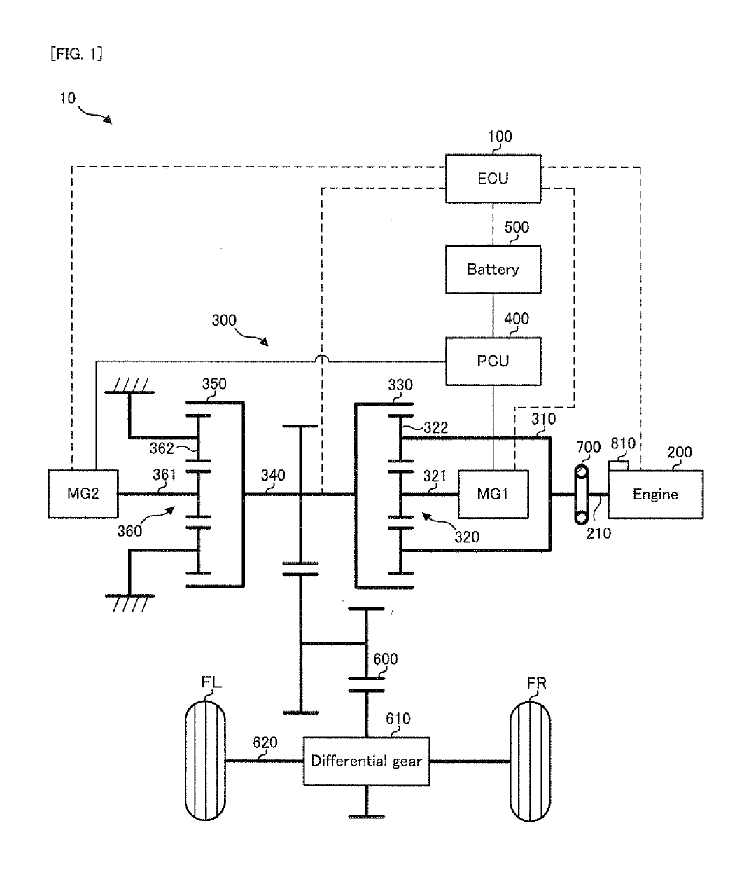

An engine starting apparatus in a first embodiment will be explained with reference to FIG. 1 to FIG. 4.

Firstly, the entire configuration of a hybrid vehicle to which the engine starting apparatus in the embodiment is applied will be explained with reference to FIG. 1.

FIG. 1 is a schematic configuration diagram conceptually showing the configuration of the hybrid vehicle in the embodiment.

In FIG. 1, a hybrid vehicle 10 in the embodiment is provided with an electronic control unit (ECU) 100, an engine 200, a motor generator MG1, a motor generator MG2, a power dividing mechanism 300, a power control unit (PCU) 400, a battery 500, a transmission mechanism 600, a differential gear 610, a transmission shaft 620, a damper 700, a crank position sensor 800, and drive wheels FR and FL.

The ECU 100 is provided with a central processing unit (CPU), a read only memory (ROM), and a random access memory (RAM) or the like, and it is an electronic control unit capable of controlling all the operations of the hybrid vehicle 10. The ECU 100 is configured to perform various controls in the hybrid vehicle 10, in accordance with a control program stored in the ROM or the like. The ECU 100 functions as one example of the “engine starting apparatus” of the present invention. Specifically, the ECU 100 functions as one example of each of the “target torque setting device” and the “motor controlling device” of the present invention.

The engine 200 is a reciprocating engine and is configured to function as the power source of the hybrid vehicle 10. The engine 200 has such a configuration that a plurality of cylinders are disposed in a cylinder block. Moreover, the engine 200 is configured such that a force generated when an air-fuel mixture including fuel is compressed in a compression stroke in each cylinder and the compressed air-fuel mixture is ignited spontaneously or by an ignition operation of a spark plug or the like is converted to a rotary motion of a crankshaft 210 through a piston and a connecting rod. The rotation of the crankshaft 210 is transmitted to the drive wheels FR and FL through the power dividing mechanism 300 and the transmission mechanism 600, whereby the hybrid vehicle 10 can be driven. Incidentally, the “engine” of the present invention includes, for example, a two-cycle or four-cycle reciprocating engine or the like and conceptually includes an engine (internal combustion engine) configured to have at least one cylinder and to extract a force generated when the air-fuel mixture including various fuels such as gasoline, light oil or alcohol is burned in a combustion chamber within the cylinder, as a driving force through a physical or mechanical transmitting device such as a piston, a connecting rod, and a crankshaft, as occasion demands. As long as the concept is satisfied, the configuration of the “engine” of the present invention is not limited to that of the engine 200 but may have various aspects.

The engine 200 is provided with a crank position sensor 810. The crank position sensor 810 can detect a crank angle CA, which is a rotation angle of the crankshaft 210, and the number of revolutions of the engine Ne, which is the number of revolutions per unit time. The crank position sensor 810 is electrically connected to the ECU 100, and the crank angle CA and the number of revolutions of the engine Ne detected are recognized by the ECU 100 with a certain or uncertain period.

The motor generator MG1 is a motor generator and has a power running function for converting electrical energy into kinetic energy and a regeneration function for converting kinetic energy into electrical energy. The motor generator MG1 is configured to function as a generator for charging the battery 500 or a generator for supplying electric power to the motor generator MG2, and as a motor for cranking the engine 200. Incidentally, the motor generator MG1 is one example of “motor” of the present invention.

The motor generator MG2, as in the motor generator MG1, has the power running function for converting electrical energy into kinetic energy and the regeneration function for converting kinetic energy into electrical energy. The motor generator MG2 is configured to function mainly as a motor for assisting (aiding) the output of the engine 200. The motor generator MG2 can transmit power to the drive wheels FR and FL through the power dividing mechanism 300, the transmission mechanism 600, the differential gear 610, and the transmission shaft 620.

Incidentally, the motor generators MG1 and MG2 may be configured, for example, as synchronous motor generators. Each of the motor generators MG1 and MG2 is provided with a rotor having a plurality of permanent magnets on an outer circumferential surface and a stator in which a three-phase coil for forming a rotating magnetic field is wound; however, of course, it may have another configuration.

The power dividing mechanism 300 is provided with a carrier 310, a first planetary gear mechanism 320, a ring gear 330, a propeller shaft 340, a ring gear 350, and a second planetary gear mechanism 360.

The first planetary gear mechanism 320 has a sun gear 321 corotationally coupled with the rotating shaft of the motor generator MG1 and a planetary gear 322 coupled with the carrier 310. The crankshaft 210 is coupled with the planetary gear 322 of the first planetary gear mechanism 320 through the damper 700 and the carrier 310. The planetary gear 322 is coupled with the ring gear 330 located on the outer circumference of the first planetary gear mechanism 320.

Thus, the rotation of the engine 200 (i.e. the rotation of the crankshaft 210) is transmitted to the sun gear 321 and the ring gear 330 through the carrier 310 and the planetary gear 322, and an output torque of the engine 200 is divided into two systems.

The propeller shaft 340, which is the rotating shaft of the ring gear 330, is coupled with the transmission mechanism 600, through which the output torque from the engine 200 is transmitted to the drive wheels FL and FR

The propeller shaft 340 is coupled with the ring gear 350 at an end opposite to an end where the propeller shaft 340 is coupled with the ring gear 330 which is coupled with a planetary gear 362 of the second planetary gear mechanism 360.

A sun gear 361 of the second planetary gear mechanism 360 is coupled with the rotating shaft of the motor generator MG2 and transmits the rotation of the motor generator MG2 to the propeller shaft 340.

The PCU 400 includes an inverter capable of converting direct-current (DC) power extracted from the battery 500 into alternating-current (AC) power and supplying it to the motor generators MG1 and MG2 and capable of converting AC power generated by the motor generators MG1 and MG2 into DC power and supplying it to the battery 500. The PCU 400 is a control unit capable of individually controlling the input/output of the electric power between the battery 500 and each motor generator. The PCU 400 is electrically connected to the ECU 100, and the operations of the PCU 400 are controlled by the ECU 100.

The battery 500 is a chargeable storage battery which functions as an electric power source associated with the electric power for the power running of the motor generators MG1 and MG2.

The transmission mechanism 600 is coupled with the power dividing mechanism 300, and it is a mechanism for transmitting the torque outputted from the engine 200 and the motor generator MG2 to the drive wheels FL and FR through the differential gear 610 and the transmission shaft 620.

The damper 700 is, for example, a torsional damper. The damper 700 is disposed between the crankshaft 210 and the power dividing mechanism 300, and has a function of attenuating torque vibration between them.

The drive wheels FL and FR transmit to a road surface the torque transmitted through the transmission mechanism 600. In FIG. 1, one wheel on the left side and one wheel on the right side are shown. The hybrid vehicle 10 is actually provided with four wheels in total, which are front, rear, left, and right wheels, including the drive wheels FL and FR.

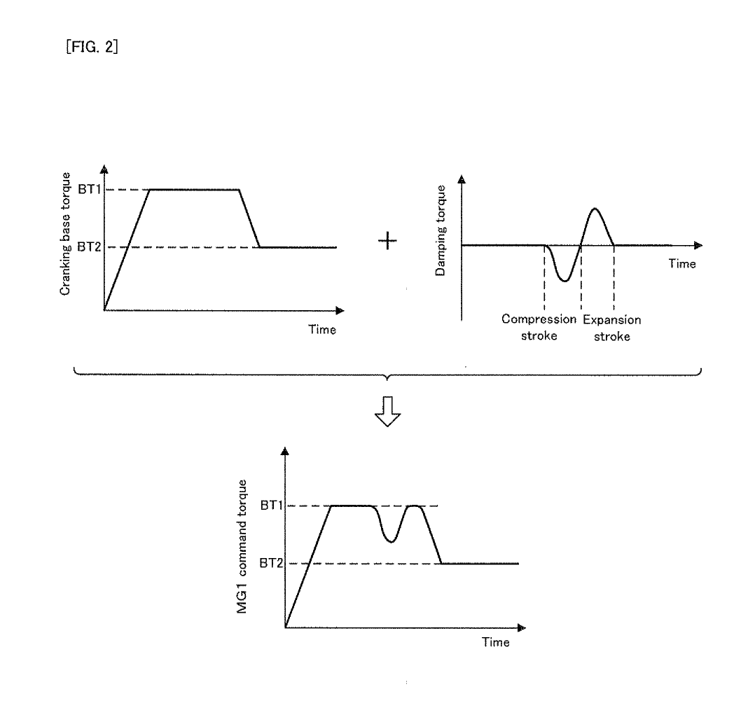

Next, the start of the engine 200 in the hybrid vehicle 10 will be explained with reference to FIG. 2.

In the hybrid vehicle 10 configured as described above with reference to FIG. 1, at the start of the engine 200, the engine 200 is cranked by the motor generator MG1 under the control of the ECU 100. Specifically, the ECU 100 sets a MG1 command torque which is a target torque to be outputted by the motor generator MG1 in cranking the engine 200 and controls the motor generator MG1 to output the MG1 command torque.

FIG. 2 is a conceptual view for explaining an outline of a method of setting the MG1 command torque in the embodiment. Incidentally, FIG. 2 shows a graph showing one example of a time-dependent change in a cranking base torque, a graph showing one example of a time-dependent change in a vibration controlling torque, and a graph showing one example of a time-dependent change in the MG1 command torque.

As shown in FIG. 2, the ECU 100 sets the sum of the cranking base torque and the vibration controlling torque, as the MG1 command torque.

The cranking base torque is a torque to be outputted by the motor generator MG1 in order to crank the engine 200, in other words, in order to increase the number of revolutions Ne of the engine 200. The cranking base torque is controlled basically to be set to a first torque value BT1 at the beginning of the cranking and to a second torque value BT2 after the number of revolutions of the engine Ne becomes greater than the predetermined number of revolutions of the engine Ne1. Incidentally, the control of the cranking base torque will be explained later in detail.

The vibration controlling torque is a torque to be outputted by the motor generator MG1 in order to suppress the vibration of a power train (i.e. a power transmission system including the damper 700, the power dividing mechanism 300, the transmission mechanism 600, and the like for transmitting the power of the engine 200 to the drive wheels FL and FR) due to the resonance of the damper 700. The vibration controlling torque is controlled to vary depending on the position of a piston of the engine 200. The vibration controlling torque is controlled such that the direction of the torque varies between a case where the piston of the engine 200 is in a compression stroke and a case where the piston of the engine 200 is in an expansion stroke. More specifically, as shown in FIG. 2, the vibration controlling torque is controlled to reduce a torque outputted by the motor generator MG1 if the piston of the engine 200 is in the compression stroke, and the vibration controlling torque is controlled to increase the torque outputted by the motor generator MG1 if the piston of the engine 200 is in the expansion stroke. In other words, the vibration controlling torque is set to a negative torque value if the piston of the engine 200 is in the compression stroke, and the vibration controlling torque is set to a positive torque value if the piston of the engine 200 is in the expansion stroke. Incidentally, in FIG. 2, a torque value in a direction of rotating the motor generator MG1 to crank the engine 200 is set to be positive, and a torque value in a direction of rotating it opposite to the above direction is set to be negative. By applying the vibration controlling torque as described above to the engine 200, it is possible to suppress the vibration of the power train due to the resonance of the damper 700.

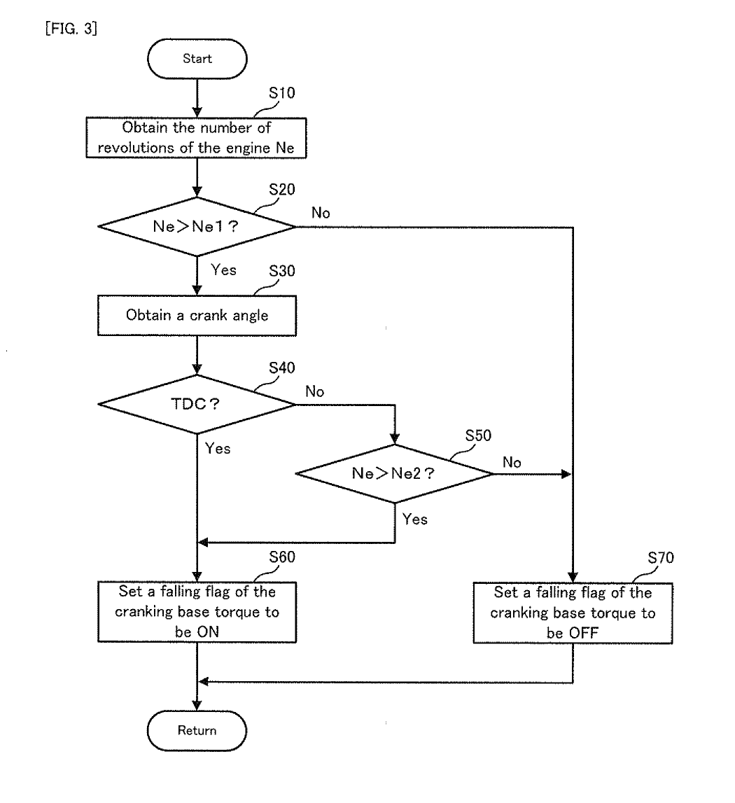

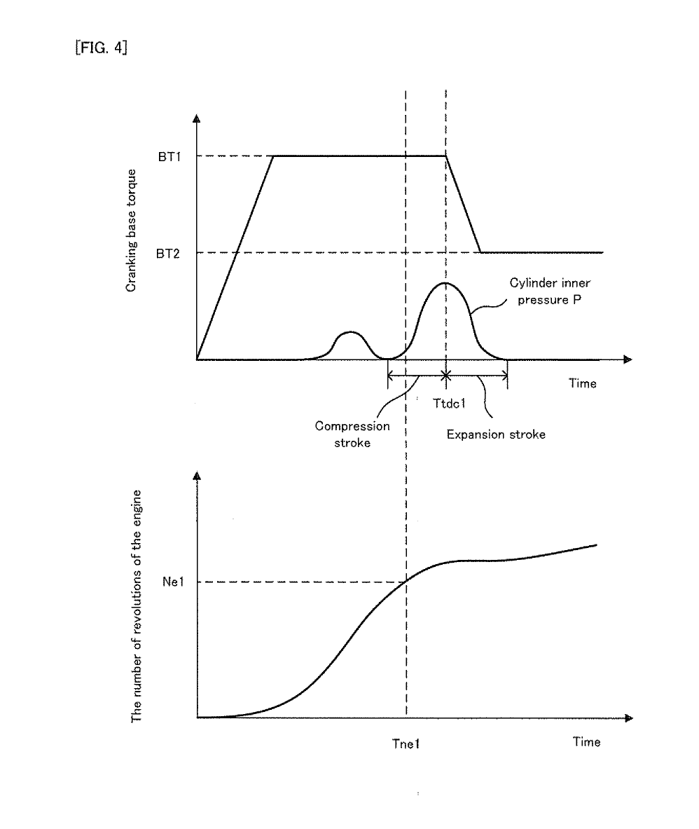

Next, the control of the cranking base torque in the embodiment will be explained in detail with reference to FIG. 3 and FIG. 4.

FIG. 3 is a flowchart showing a flow of controlling the cranking base torque in the embodiment. FIG. 4 is a graph showing one example of the time-dependent change in the cranking base torque and the number of revolutions of the engine in the embodiment. Incidentally, the graph which shows one example of the time-dependent change in the cranking base torque also shows one example of a time-dependent change in a cylinder inner pressure P, which is a pressure within the cylinder of the engine 200.

In FIG. 3 and FIG. 4, if the cranking of the engine 200 is started, the number of revolutions of the engine 200 is obtained by the ECU 100 (step S100). In other words, the ECU 100 obtains from the crank position sensor 810 the number of revolutions of the engine detected by the crank position sensor 810. Incidentally, as describe above with reference to FIG. 2, the cranking base torque is set to the first torque value BT1 at the beginning of the craning. By applying the torque from the motor generator MG1, the number of revolutions of the engine 200 is increased.

Then, it is judged by the ECU 100 whether or not the number of revolutions of the engine Ne is greater than the predetermined number of revolutions of the engine Ne1 (step S20). Incidentally, in FIG. 4, a time point at which the number of revolutions of the engine Ne reaches the predetermined number of revolutions of the engine Ne1 is shown as a time point Tne1.

If it is judged that the number of revolutions of the engine Ne is greater than the predetermined number of revolutions of the engine Ne1 (the step S20: Yes), the crank angle CA is obtained by the ECU 100 (step S30). In other words, the ECU 100 obtains from the crank position sensor 810 the crank angle CA detected by the crank position sensor 810.

Then, it is judged by the ECU 100 whether or not the piston of the engine 200 is at a top dead center (TDC) (step S40). The ECU 100 judges whether or not the piston of the engine 200 is at the TDC on the basis of the obtained crank angle CA. Incidentally, in FIG. 4, a time point at which the piston of the engine 200 reaches the TDC for the first time after the time point Tne1 at which the number of revolutions of the engine Ne reaches the predetermined number of revolutions of the engine Ne1 is shown as a Ttdc1.

If it is judged that the piston of the engine 200 is at the TDC (the step S40: Yes), a falling flag of the cranking base torque is set to be ON by the ECU 100 (step S60). Here, the falling flag of the cranking base torque is a flag indicating whether or not the cranking base torque is reduced from the current torque value. If the falling flag of the cranking base torque is ON, the ECU 100 reduces the cranking base torque from the current torque value, and if the falling flag of the cranking base torque is OFF, the ECU 100 maintains the cranking base torque at the current torque value. In other words, if judging that the piston of the engine 200 is at the TDC, the ECU 100 sets the falling flag of the cranking base torque to be ON and reduces the cranking base torque from the first torque value BT1. More specifically, as shown in FIG. 4, the ECU 100 controls the cranking base torque to start to be reduced from the first torque value BT1 at the time point Ttdc1 at which the piston of the engine 200 reaches the TDC for the first time after the number of revolutions of the engine Ne becomes greater than the predetermined number of revolutions of the engine Ne1 (i.e. after the time point Tne1) and to be the second torque value BT2 during the expansion stroke after the TDC.

Thus, for example, it is possible to reduce the power consumption of the motor generator MG1 in the expansion stroke after the number of revolutions of the engine Ne reaches the predetermined number of revolutions of the engine Ne1, in comparison with a case where the cranking base torque is set to the first torque value BT1 even in the expansion stroke after the number of revolutions of the engine Ne reaches the predetermined number of revolutions of the engine Ne1. Therefore, it is possible to reduce the rated output of the battery 500 (the maximum value of the electric power that the battery 500 can output) for supplying the electric power to the motor generator MG1, thereby miniaturizing the battery 500. The miniaturization of the battery 500 makes it possible to reduce the vehicle weight of the hybrid vehicle 10, to improve a fuel consumption rate, and to reduce cost.

If it is judged that the piston of the engine 200 is not at the TDC (the step S40: No), it is judged by the ECU 100 whether or not the number of revolutions of the engine Ne is greater than the predetermined number of revolutions of the engine Net (step S50).

If it is judged that the number of revolutions of the engine Ne is greater than the predetermined number of revolutions of the engine Ne2 (the step S50: Yes), the falling flag of the cranking base torque is set to be ON by the ECU 100 (the step S60).

If it is judged that the number of revolutions of the engine Ne is not greater than the predetermined number of revolutions of the engine Ne2 (i.e. that the number of revolutions of the engine Ne is less than or equal to the predetermined number of revolutions of the engine Ne2) (the step S50: No), the falling flag of the cranking base torque is set to be OFF by the ECU 100 (step S70). In other words, the ECU 100 maintains the cranking base torque at the first torque value BT1.

On the other hand, if it is judged that the number of revolutions of the engine Ne is not greater than the predetermined number of revolutions of the engine Ne1 (the step S20: No), the falling flag of the cranking base torque is set to be OFF by the ECU 100 (the step S70).

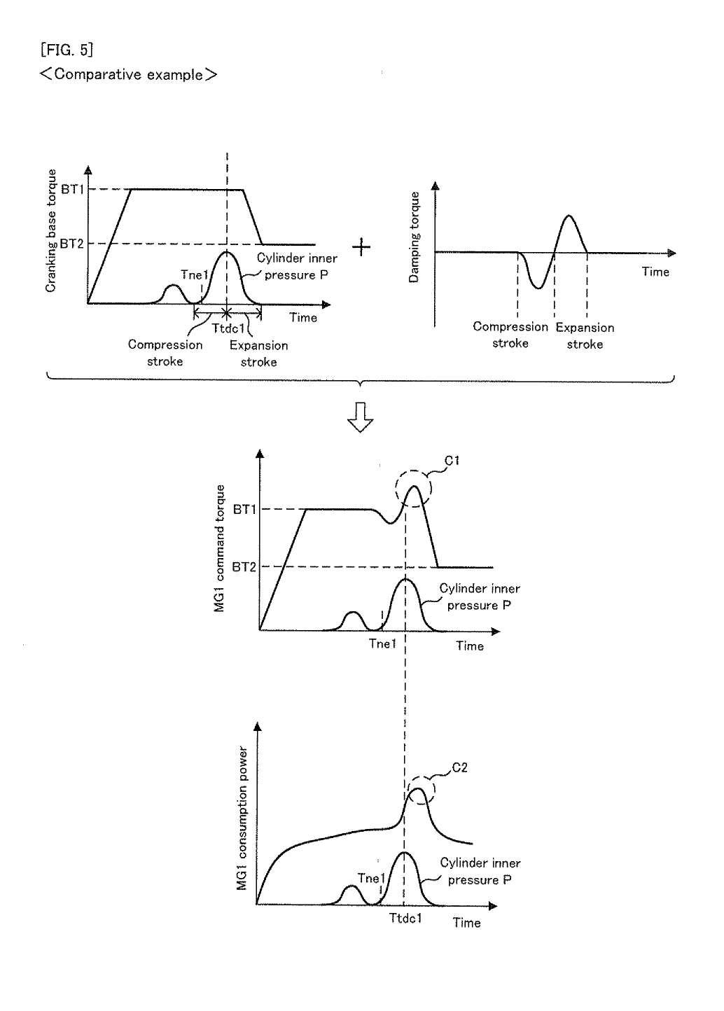

Next, with reference to FIG. 5, an explanation will be given on a method of setting a MG1 command torque by an engine starting apparatus in a comparative example and on an effect by the control of the cranking base torque in the embodiment.

FIG. 5 is a conceptual view for explaining an outline of the method of setting the MG1 command torque in the comparative example. Incidentally, FIG. 5 shows a graph showing one example of a time-dependent change in the cranking base torque in the comparative example, a graph showing one example of a time-dependent change in the vibration controlling torque in the comparative example, and a graph showing one example of a time-dependent change in the MG1 command torque in the comparative example.

As shown in FIG. 5, the engine starting apparatus in the comparative example is configured to be different from the engine starting apparatus in the embodiment in that the cranking base torque is set to the first torque value BT1 even in the expansion stroke after the number of revolutions of the engine Ne reaches the number of revolutions of the engine Ne1 (i.e. after the time point Tne1). The engine starting apparatus in the comparative example is configured to be substantially the same as the engine starting apparatus in the embodiment in other points.

According to such a comparative example, the MG1 command torque is maximal in the expansion stroke after the time point Tne1 at which the number of revolutions of the engine Ne reaches the number of revolutions of the engine Ne1 (refer to a portion surrounded by a dashed line circle C1 in FIG. 5). Thus, the power to be outputted by the motor generator MG1, in other words, the power consumption of the motor generator MG1 (i.e. MG1 power consumption) is also maximal in the expansion stroke after the time point Tne1 (refer to a portion surrounded by a dashed line circle C2 in FIG. 5).

Here, in the expansion stroke, the rotation of the crankshaft is accelerated by the expansion of the air compressed in the cylinder in the compression stroke. Thus, like this comparative example, if the cranking base torque is maintained at the first torque value BT1 as in the compression stroke even in the expansion stroke, the rotation of the crankshaft is wastefully accelerated. In other words, according to the comparative example, the MG1 power consumption is increased due to the wasteful acceleration. As a result, it is hard to reduce the rated output of the battery.

However, according to the embodiment, as described above, the cranking base torque is controlled to start to be reduced from the first torque value BT1 at the time point Ttdc1 at which the piston of the engine 200 reaches the TDC for the first time after the number of revolutions of the engine Ne becomes greater than the predetermined number of revolutions of the engine Ne1 (i.e. after the time point Tne1) and to be the second torque value BT2 during the expansion stroke after the TDC. Thus, it is possible to reduce the power consumption of the motor generator MG1 during the expansion stroke and to reduce the rated output of the battery 500.

As explained above, according to the engine starting apparatus in the embodiment, it is possible to suppress the vibration of the power train due to the resonance of the damper 700 at the start of the engine 200 and to suppress the power consumption of the motor generator MG1.

### Second Embodiment

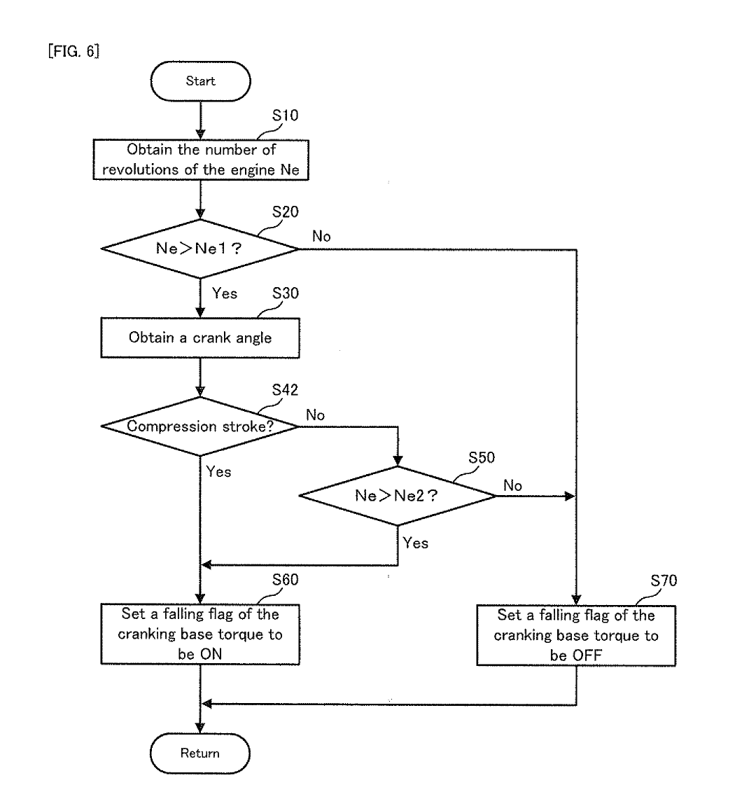

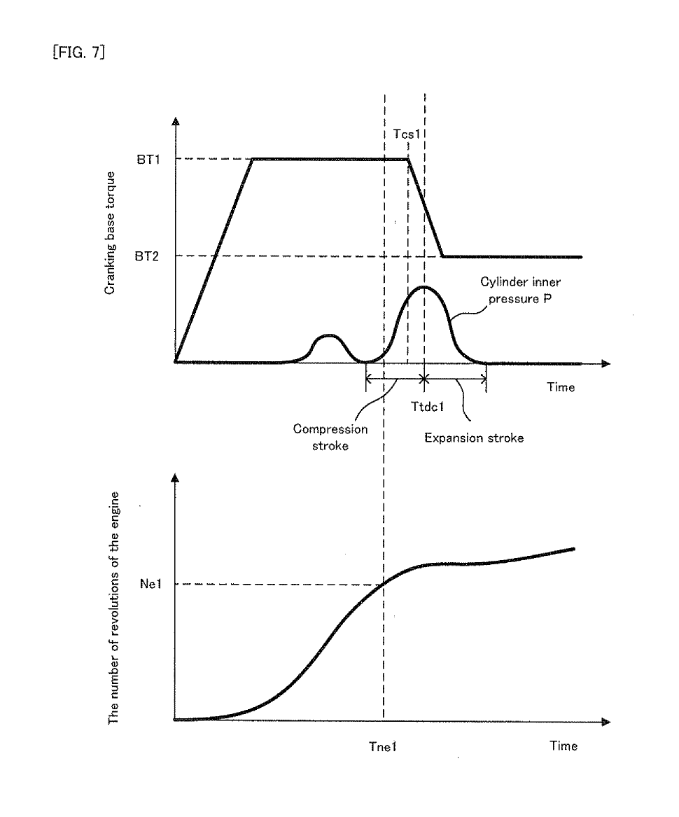

An engine starting apparatus in a second embodiment will be explained with reference to FIG. 6 and FIG. 7.

FIG. 6 is a flowchart showing a flow of controlling the cranking base torque in the second embodiment. FIG. 7 is a graph showing one example of a time-dependent change in the cranking base torque and the number of revolutions of the engine in the second embodiment. Incidentally, in FIG. 6, the same steps as those in the control of the cranking base torque in the first embodiment shown in FIG. 4 will carry the same step numbers, and the explanation thereof will be omitted as occasion demands.

In FIG. 7, the engine starting apparatus in the second embodiment is configured to be different from the engine starting apparatus in the first embodiment described above in the point of controlling the cranking base torque to start to be reduced from the first torque value BT1 at a time point Tcs1 at which the piston of the engine 200 reaches the compression stroke for the first time after the number of revolutions of the engine Ne becomes greater than the predetermined number of revolutions of the engine Ne1 (i.e. after the time point Tne1) and to be the second torque value BT2 during the expansion stroke after the compression stroke. The engine starting apparatus in the second embodiment is configured to be substantially the same as the engine starting apparatus in the first embodiment described above in other points.

In FIG. 6, if it is judged that the number of revolutions of the engine Ne is greater than the predetermined number of revolutions of the engine Ne1 (the step S20: Yes), the crank angle CA is obtained by the ECU 100 (the step S30). Then, it is judged by the ECU 100 whether or not the piston of the engine 200 is in the compression stroke (step S42). The ECU 100 judges whether or not the piston of the engine 200 is in the compression stroke on the basis of the obtained crank angle CA.

If it is judged that the piston of the engine 200 is in the compression stroke (the step S42: Yes), the falling flag of the cranking base torque is set to be ON by the ECU 100 (the step S60).

If it is judged that the piston of the engine 200 is not in the compression stroke (the step S42: No), it is judged by the ECU 100 whether or not the number of revolutions of the engine Ne is greater than the predetermined number of revolutions of the engine Ne2 (the step S50).

In other words, in the embodiment, as shown in FIG. 7, the ECU 100 controls the cranking base torque to start to be reduced from the first torque value BT1 at the time point Tcs1 at which the piston of the engine 200 reaches the compression stroke for the first time after the number of revolutions of the engine Ne becomes greater than the predetermined number of revolutions of the engine Ne1 (i.e. after the time point Tne1) and to be the second torque value BT2 during the expansion stroke after the compression stroke.

Thus, according to the embodiment, as in the first embodiment described above, for example, it is possible to reduce the power consumption of the motor generator MG1 in the expansion stroke after the number of revolutions of the engine Ne reaches the predetermined number of revolutions of the engine Ne1, in comparison with the case where the cranking base torque is set to the first torque value BT1 even in the expansion stroke after the number of revolutions of the engine Ne reaches the predetermined number of revolutions of the engine Ne1.

### Third Embodiment

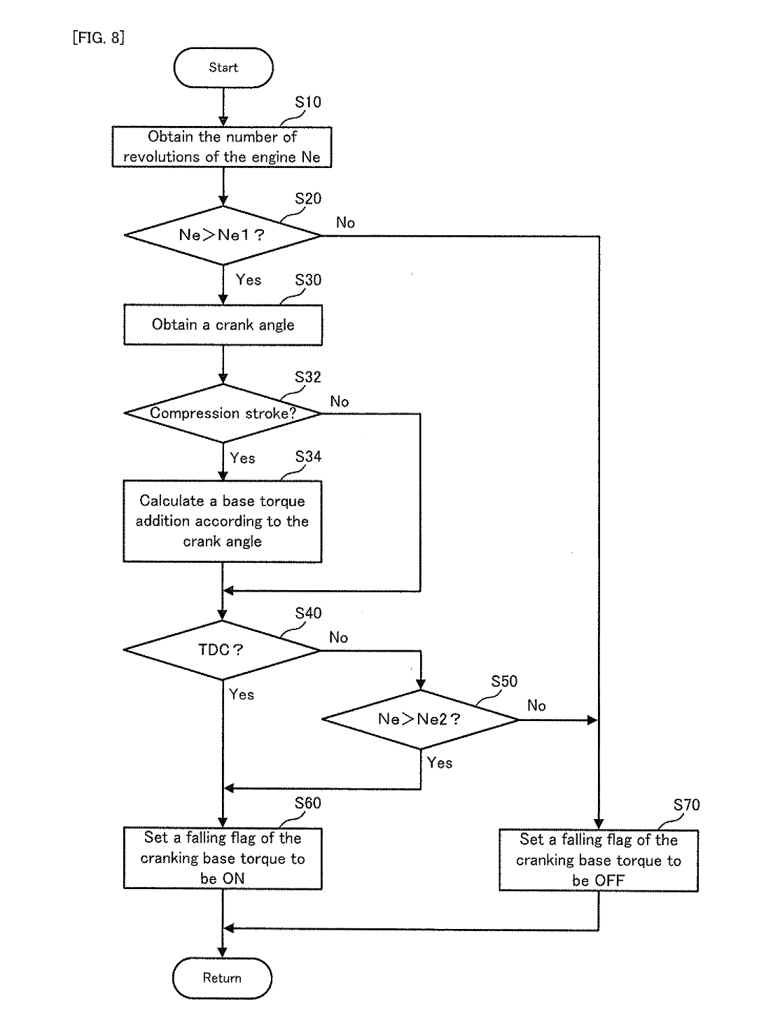

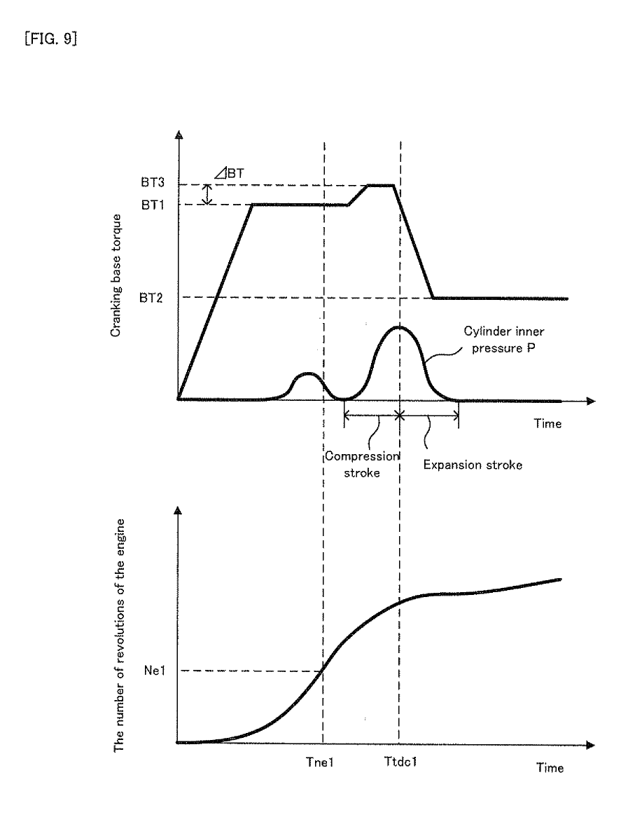

An engine starting apparatus in a third embodiment will be explained with reference to FIG. 8 and FIG. 9.

FIG. 8 is a flowchart showing a flow of controlling the cranking base torque in the third embodiment. FIG. 9 is a graph showing one example of a time-dependent change in the cranking base torque and the number of revolutions of the engine in the third embodiment. Incidentally, in FIG. 8, the same steps as those in the control of the cranking base torque in the first embodiment shown in FIG. 4 will carry the same step numbers, and the explanation thereof will be omitted as occasion demands.

In FIG. 9, the engine starting apparatus in the third embodiment is configured to be different from the engine starting apparatus in the first embodiment described above in the point of controlling the cranking base torque to be greater than the first torque value BT1 in at least one portion of a period in which the piston of the engine 200 is in the compression stroke for the first time after the number of revolutions of the engine Ne becomes greater than the predetermined number of revolutions of the engine Ne1 (i.e. after the time point Tne1). The engine starting apparatus in the third embodiment is configured to be substantially the same as the engine starting apparatus in the first embodiment described above in other points.

In FIG. 8, if it is judged that the number of revolutions of the engine Ne is greater than the predetermined number of revolutions of the engine Ne1 (the step S20: Yes), the crank angle CA is obtained by the ECU 100 (the step S30). Then, it is judged by the ECU 100 whether or not the piston of the engine 200 is in the compression stroke (step S32). The ECU 100 judges whether or not the piston of the engine 200 is in the compression stroke on the basis of the obtained crank angle CA.

If it is judged that the piston of the engine 200 is in the compression stroke (the step S32: Yes), a base torque addition ΔBT according to the crank angle CA is calculated by the ECU 100 (step S34). In other words, if judging that the piston of the engine 200 is in the compression stroke, the ECU 100 calculates the base torque addition ΔBT according to the crank angle CA and adds the calculated base torque addition ΔBT to the cranking base torque. Namely, as shown in FIG. 9, the ECU 100 controls the cranking base torque to be a third torque value BT3 which is greater than the first torque value BT1 in at least one portion of the period in which the piston of the engine 200 is in the compression stroke for the first time after the number of revolutions of the engine Ne becomes greater than the predetermined number of revolutions of the engine Ne1 (i.e. after the time point Tne1). Incidentally, the third torque value BT3 is a value obtained by adding the base torque addition ΔBT to the first torque value BT1.

Thus, according to the embodiment, it is possible to reduce or prevent that an increase in the number of revolutions of the engine is suppressed by the compressed air in the cylinder of the engine 200, in the period in which the piston of the engine 200 is in the compression stroke. This makes it possible to suppress an increased difference in the rate of increase in the number of revolutions of the engine between the period in which the piston of the engine 200 is in the compression stroke and a period in which the piston of the engine is in the subsequent expansion stroke. Thus, the vibration of the power train for transmitting the power of the engine 200 can be also suppressed.

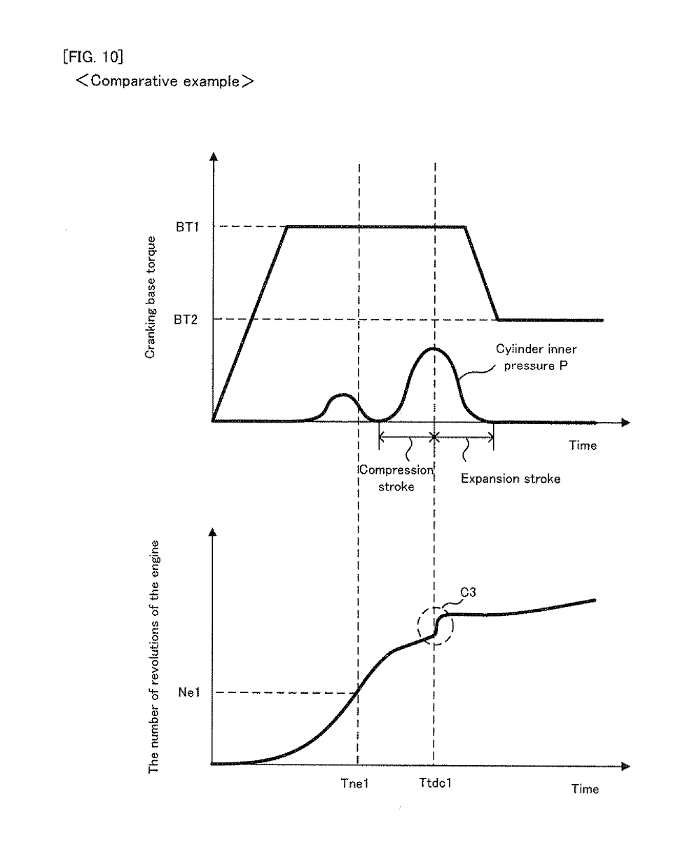

FIG. 10 is a graph showing one example of a time-dependent change in the cranking base torque and the number of revolutions of the engine in the comparative example described above with reference to FIG. 5.

In FIG. 10, the engine starting apparatus in the comparative example sets the cranking base torque to the first torque value BT1 even in the expansion stroke after the number of revolutions of the engine Ne reaches the number of revolutions of the engine Ne1 (i.e. after the time point Tne1), as described above with reference to FIG. 5.

Here, in the expansion stroke, the rotation of the crankshaft is accelerated by the expansion of the air compressed in the cylinder in the compression stroke. Thus, like this comparative example, if the cranking base torque is maintained at the first torque value BT1 as in the compression stroke even in the expansion stroke, that increases a difference in the rate of increase in the number of revolutions of the engine between the period in which the piston of the engine 200 is in the compression stroke and the period in which the piston of the engine is in the subsequent expansion stroke (in other words, between before and after the time point Ttdc1) (refer to a portion surrounded by a dashed line circle C3 in FIG. 10). This may increase the vibration of the power train for transmitting the power of the engine 200.

However, according to the embodiment, as described above, the cranking base torque is controlled to be the third torque value BT3 which is greater than the first torque value BT1 in the period in which the piston of the engine 200 is in the compression stroke for the first time after the number of revolutions of the engine Ne becomes greater than the predetermined number of revolutions of the engine Ne1 (i.e. after the time point Tne1). Thus, it is possible to suppress an increased difference in the rate of increase of in the number of revolutions of the engine between before and after the time point Ttdc1.

The present invention is not limited to the aforementioned embodiments, but various changes may be made, if desired, without departing from the essence or spirit of the invention which can be read from the claims and the entire specification. An engine starting apparatus, which involves such changes, is also intended to be within the technical scope of the present invention.

### DESCRIPTION OF REFERENCE CODES

10 hybrid vehicle
100 ECU
200 engine
210 crankshaft
300 power dividing mechanism
400 PCU
500 battery
600 transmission mechanism
610 differential gear
620 transmission shaft
700 damper
810 crank position sensor
FL, FR drive wheel
MG1, MG2 motor generator

1. An engine starting apparatus installed in a vehicle comprising: an engine; a motor capable of cranking the engine; a power transmission system, including a damper, for transmitting power of the engine to drive wheels; and a battery capable of supplying electric power to the motor, said engine starting apparatus comprising:
a target torque setting device for setting a sum of a cranking base torque for cranking the engine and a vibration controlling torque for suppressing vibration of the power transmission system due to resonance of the damper, as a target torque to be outputted by the motor in cranking the engine; and
a motor controlling device for controlling the motor to output the set target torque,
said target torque setting device having a base torque controlling device for setting the cranking base torque to a first torque value if the number of revolutions of the engine is less than or equal to predetermined number of revolutions of the engine and for controlling the cranking base torque such that the cranking base torque starts to be reduced at a time point at which a piston of the engine is at a top dead center or in a compression stroke and such that the cranking base torque is a second torque value which is less than the first torque value at a time point at which the piton is in an expansion stroke if the number of revolutions of the engine is greater than the predetermined number of revolutions of the engine.

2. The engine starting apparatus according to claim 1, wherein the base torque controlling device controls the cranking base torque such that the cranking base torque is greater than the first torque value in at least one portion of a period in which the piston in the compression stroke.
